(19) United States
(12) Patent Application Publication
(10) Pub. No.: US 2005/0003066 A1
(43) Pub. Date: Jan. 6, 2005

(54) Food intermediate having enhanced shape retention and organoleptic properties and methods of producing the dough intermediate

(76) Inventors: Madonna M. Ray, Vadnais Heights, MN (US); Trudi R. Rodne, Eagan, MN (US); Yang Kou, Minneapolis, MN (US); Susan S. Heddleson, Plymouth, MN (US); Annavarapu S. Murty, Spring Valley, WI (US); Ryan M. Check, Maple Grove, MN (US)

Correspondence Address: GENERAL MILLS, INC., P.O. BOX 1113, MINNEAPOLIS, MN, 55440, US

(21) Appl. No.: 10/611,761

(22) Filed: Jul. 1, 2003

(51) Int. Cl. A21D 10/00

(52) U.S. Cl. 426/549

(57) ABSTRACT

The present invention relates to dough intermediates that yield enhanced organoleptic attributes as well as aesthetic features upon subjecting the dough intermediate to a finishing step. The beneficial features of the present invention are obtained through the creation of a partially sealed layer on the surface of the dough intermediate. The sealing of the intermediate allows for increased expansion through the mixing and proofing stages by increasing fluidity of the dough intermediate and restricting dehydration at the surface and as such contributes to yield improvement better shape definition.

### CROSS-REFERENCES TO RELATED APPLICATIONS

None.

### FIELD OF THE INVENTION

The present invention relates to food intermediates, more particularly dough intermediates, having improved shape retention, enhanced oven spring and reduced crust to crust sticking that are obtained through the application of liquefied fat or oil to the dough intermediate prior to completing the transitional steps necessary to achieve the final baked product. The resulting dough product has improved organoleptic properties.

### BACKGROUND OF THE INVENTION

In today's marketplace, there are a number of frozen and refrigerated products that purport to offer the consumer convenience as well as a potentially satiating food offering, hopefully reminiscent of home baked goods. However, unfortunately, many commercially produced products simply do not have the aesthetic appeal that consumers often seek and desire and as such may be disappointed in the overall culinary experience after preparation of the product. This dissatisfaction results in a loss of repeat purchases and hence business for the manufacturer.

The foregoing problem can be further exacerbated in food service applications, such as restaurants, cafeteria's and the like. Such food service outlets attempt to deliver a sampling of food products that enrich the consumer's dining experience and hence stir repeat business in light of the end result of the preparation. However, while food service outlets strive for such deliverables, cost and time constraints require such outlets to use prepared food products in order to “turn tables” as quickly as possible and build the flow of customers through the establishment.

One of the difficulties associated with frozen and refrigerated dough products that make up today's food service offerings and retail product presentations is that the products do not increase significantly in volume or size from that of their frozen or refrigerated condition. That is, such products often remain relatively small and the perception of freshness to the consumer is limited. In addition, such products can feel heavy to the consumer after consumption, due to the dense structure of the product.

What is needed therefore is a food product that meets the needs of food service and retail outlets with respect to ease of preparation and handling but which yields a product that manifests improved organoleptic properties when compared with current product offerings.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to an improved dough intermediate that is presented in a partially baked or “par-baked” configuration to a retail, wholesale or food service outlet. The dough intermediate as provided herein yields a consumer food product having enhanced organoleptic properties and desirable shape and aesthetic properties.

In one exemplary embodiment of the present invention a dough intermediate that is formed from a mixture as described that has the capability to produce a shape that has desirable aesthetic features that appear upon subjecting the dough intermediate to a finishing step. The aesthetic features of the dough intermediate are created through stamping, cutting, slicing or combinations thereof and produce a series of lobes, sections, portions or combinations thereof that are visible after subjecting the dough intermediate to the finishing step.

The features of the dough intermediate of the present invention are obtained through the use of a plasticizing agent that is applied to the dough intermediate at least prior to the finishing step. The plasticizing agent is applied so as to substantially coat an external surface of the intermediate to form a plasticized layer on the external surface of the dough intermediate. The plasticized layer forms a partially sealed layer that increases the fluidity of the dough intermediate rheology, slows dehydration of the dough surface, and allows for additional expansion capacity.

When the dough intermediate is subjected to a finishing step, the dough intermediate with the plasticized layer yields an enhanced crown or cap and baked specific volume of greater than 3 ml/g and preferably greater than 5 ml/g. One of the most important characteristics of a baked product is the product's baked specific volume (“BSV”). The BSV of a product relates the volume of the baked product to the weight of the product. Generally, products with higher BSVs are lighter and have more gas or air incorporated therein. Products with lower BSVs are heavy, dense and generally undesirable in developed doughs.

In a still further exemplary embodiment of the present invention, a method of preparing the dough intermediate is described. The illustrative method of preparing a dough intermediate that has improved aesthetic and organoleptic properties upon subjecting the dough intermediate to a finishing step includes the steps of initially preparing a dough that has desirable properties for the particular end use selected. Once the dough is prepared, individual dough intermediates are produced.

Next, a plasticizing agent is applied to an external surface of the dough intermediate to form a partially sealed layer on the surface of the dough intermediate. Then, a cutting force is applied to each of the individual dough intermediates to form a plurality of lobes, sections, portions or the like on each of the dough intermediates. The cutting force may be applied either before the application of the plasticizing agent or after.

The dough intermediate is then treated to a partial finishing step to create a partially baked dough intermediate which is then suitable for delivery to retail, wholesale or food service outlets. Finally, each of the partially baked dough intermediates is subjected to a final finishing step so as to yield a baked product having improved organoleptic and aesthetic properties.

The exemplary method described above may also include a second or more applications of the plasticizing agent after the final finishing step has been completed. Such a further application may also contribute to creating a sheen on the surface of the baked product improving the presentation of the baked product and significantly increasing liking to the ultimate intended consumer.

The plasticizing agent of the present invention may be selected from the group including butter, oil, margarine, liquefied fat and combinations thereof.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a flow diagram used in preparing the food intermediate of the present invention;

FIG. 2 illustrates the food product prepared from the intermediate of the present invention; and

FIG. 3 provides a cut away of the final food product prepared from the intermediate of the present invention illustrating the plasticized layer adjacent the crown or edge of the food product.

### DETAILED DESCRIPTION OF THE INVENTION

The present invention is now illustrated in greater detail by way of the following detailed description, but it should be understood that the present invention is not to be construed as being limited thereto.

As used herein, the term dough intermediate refers to dough-based products, such as rolls, biscuits, buns, cinnamon rolls, croissants, pastries and the like which undergo a further processing step by the end user, such as baking, frying or heating.

Surprisingly, it has been found that by applying a liquid fat or oil to the surface of the dough intermediate prior to a finishing step such as baking, frying or heating that a baked food product can be obtained having enhanced oven spring (volume that increases during proofing and baking), better shape retention, reduced crust sticking and crust delamination.

While not wishing to be bound by any particular theory, it is believed that the fat or oil plasticizes on the surface or areas where the material is sprayed, forming at least a partial seal on the surface to which the fat or oil has been applied. The coating spray increases dough fluidity and slows dehydration of the dough intermediate so as to increase in the volume of the finished baked good and creating greater spring during proofing and baking. In addition, the fat or oil, such as butter oil, is absorbed into the surface of the dough allowing for concentrated flavor release over a large surface area once the dough intermediate has been baked by the consumer or end user as the fat or oil remains near the surface of the baked product and contacts the sensory taste glands of the consumer.

The coating spray forms a plasticizing layer over substantially the entire area of the exposed surface of the dough, more specifically, that portion of the dough intermediate that will become the crown or cap of the finished baked good as well as possibly the upper walls adjacent the crown or cap.

Exemplary methods that may be suitable for use in accordance with the present invention can also be used to make a variety of food intermediates such as refrigerated and frozen doughs, including doughs for breads, such as French bread, wheat refrigerated and frozen doughs, bread, white bread, corn bread, rolls, such as cinnamon rolls, dinner rolls, caramel rolls, buns and other assorted baked goods such as breadsticks, croissants, pastries, biscuits, pizza dough, and the like. Additionally, the invention can be used to make non-refrigerated doughs, such as doughs that are immediately baked or doughs that are prepared from dry mixes. Virtually any dough can be mixed using a method of the invention.

The attainment of certain dough characteristics are more important in some doughs than in others, and depend largely on the intended end use of the dough product. In particular embodiments, a method of the invention will be more advantageously used in certain varieties of doughs. For example, dough extensibility is more important in developed doughs than in undeveloped doughs. Developed doughs are those in which the protein network has been more or less fully formed or created. Examples of developed doughs include dough for breads or rolls. Undeveloped doughs are those in which the protein network is not yet fully formed. Examples of undeveloped doughs include but are not limited to biscuit dough.

Dough formulations, and the ingredients they contain, can differ depending on the finished product that is obtained from the dough. However, most doughs do generally have a number of ingredients in common and examples of some such common ingredients are described and illustrated in more detail below.

The dough of the invention generally contains a grain constituent that contributes to the structure of the dough. Different grain constituents lend different texture, taste and appearance to a baked good. Flour is the most commonly used grain constituent in baked goods, and in most baked foods is the primary ingredient.

Suitable flours include hard wheat flour, soft wheat flour, corn flour, high amylose flour, low amylose flour, and the like. For example, a dough product made with a hard wheat flour will have a more coarse texture than a dough made with a soft wheat flour due to the presence of a higher amount of gluten in hard wheat flour.

Bread flours are primarily milled from hard red winter or spring wheats. Generally these flours have a protein content of about 11.0-12.5%. Certain baked products may require stronger bread flours with about 1-2% higher protein content. In bread making, flour may comprise up to about 95% of the ingredients (in a dry weight basis). In bread, when the flour comes in contact with water, and the ingredients are mixed, the gluten protein fraction forms elastic, gas-retaining films.

The doughs of the invention also generally include leavening agents that increase the volume and alter the texture of the final baked good. Such leavening agents can either be chemical leavening agents or yeast.

Chemical leavening typically involves the interaction of at least one leavening acid and at least one leavening base. The leavening acid generally triggers the release of carbon dioxide from the leavening base upon contact with moisture. The carbon dioxide gas aerates the dough or batter during mixing and baking to provide a light, porous cell structure, fine grain, and a texture with a desirable appearance and palatability.

The evolution of carbon dioxide essentially follows the stoichiometry of typical acid-base reactions. The amount of leavening base present determines the amount of carbon dioxide evolved, whereas the type of leavening acid affects the speed at which the carbon dioxide is liberated. The amount of leavening base used in combination with the leavening acid can be balanced such that a minimum of unchanged reactants remain in the finished product. An excess amount of leavening base can impart a bitter flavor to the final product, while excess leavening acid can make the baked product tart.

Sodium bicarbonate, or baking soda, a leavening base, is the primary source of carbon dioxide gas in many chemical-leavening systems. This compound is stable and relatively inexpensive to produce. Other leavening bases include for example potassium bicarbonate, ammonium carbonate and ammonium bicarbonate.

Leavening bases can be modified in order to alter the way in which they work. For example, they can be encapsulated. Encapsulated leavening bases, such as encapsulated baking soda, will tend to delay the onset of the leavening reaction because the encapsulating material must dissolve before the leavening reaction can occur.

Generally, the method of the invention can utilize modified or non-modified leavening bases as part of a chemical leavening system. Specifically, however, one embodiment of the invention utilizes non-encapsulated leavening bases as part of the chemical leavening system.

Leavening acids include sodium or calcium salts of ortho, pyro, and complex phosphoric acids in which at least two active hydrogen ions are attached to the molecule. Baking acids include compounds such as monocalcium phosphate monohydrate (MCP), monocalcium phosphate anhydrous (AMCP), sodium acid pyrophosphate (SAPP), sodium aluminum phosphate (SALP), dicalcium phosphate dehydrate (DPD), dicalcium phosphate (DCP), sodium aluminum sulfate (SAS), glucono-delta-lactone (GDL), and potassium hydrogen tartrate (cream of tartar).

Yeast is also utilized for leavening baked goods, and is often preferred because of the desirable flavor it imparts to the dough. Bakers' yeast is supplied in three forms: yeast cream, a thick suspension with about 17% solids; a moist press cake with about 30% solids; and an active dry yeast, with about 93 to 98% solids. Generally, active dry yeasts of acceptable quality have been available for some time, and recently instant active dry yeast has also been available for commercial use.

The quantity of yeast added to dough is directly related to the time required for fermentation, and the form of the yeast utilized. Generally, most bread doughs are made with from about 2 to 3% fresh compressed yeast, based on the amount of flour.

Methods of the invention can be used with either chemical or yeast leavened doughs.

The dough of the invention can also contain additional ingredients. Some such additional ingredients can be used to modify the texture of dough. Texture modifying agents can improve many properties of the dough, such as viscoelastic properties, plasticity, or dough development. Examples of texture modifying agents include fats, emulsifiers, hydrocolloids, and the like.

Shortening helps to improve the volume, grain and texture of the final product. Shortening also has a tenderizing effect and improves overall palatability and flavor of a baked good. Either natural shortenings, animal or vegetable, or synthetic shortenings can be used. Generally, shortening is comprised of triglycerides, fats and fatty oils made predominantly of triesters of glycerol with fatty acids. Fats and fatty oils useful in producing shortening include cotton seed oil, ground nut oil, soybean oil, sunflower oil, rapeseed oil, sesame oil, olive oil, corn oil, safflower oil, palm oil, palm kernel oil, coconut oil, or combinations thereof.

Emulsifiers include nonionic, anionic, and/or cationic surfactants that can be used to influence the texture and homogeneity of a dough mixture, increase dough stability, improve eating quality, and prolong palatability. Emulsifiers include compounds such as lecithin, mono- and diglycerides of fatty acids, propylene glycol mono- and diesters of fatty acids, glyceryl-lacto esters of fatty acids, and ethoxylated mono- and diglycerides.

Hydrocolloids are added to dough formulations to increase moisture content, and to improve viscoelastic properties of the dough and the crumb texture of the final product. Hydrocolloids function both by stabilizing small air cells within the batter and by binding to moisture within the dough. Hydrocolloids include compounds such as xanthan gum, guar gum, and locust bean gum.

Although the invention is meant to replace the use of dough conditioners for purposes such as increasing the extensibility or decreasing the energy of mixing for the dough, certain embodiments may also include dough conditioners which may or may not be used to have the same effect.

Dough-developing agents can also be added to the system to increase dough viscosity, texture and plasticity. Any number of agents known to those of skill in the art may be used including azodicarbonamide, diacetyl tartaric acid ester of mono- and diglycerides (D.A.T.E.M.) and potassium sorbate.

Another example of a dough-developing additive is PROTASE™. PROTASE™ is a proprietary product containing enzymes and other dough conditioners. PROTASE™ is generally used to reduce mixing time and improve machinability. PROTASE 2×™, a double strength version can be commercially obtained from J. R. Short Milling Co., Chicago, Ill.

Dough conditioners are also examples of dough additives. One example of a dough conditioner is NUBAKE™, commercially available from RIBUS (St. Louis, Mo.). Another example of a dough conditioner is L-cysteine, commercially available from B.F. Goodrich (Cincinnati, Ohio).

Dough can also frequently contain nutritional supplements such as vitamins, minerals and proteins, for example. Examples of specific nutritional supplements include thiamin, riboflavin, niacin, iron, calcium, or mixtures thereof.

Dough can also include flavorings such as sweeteners, spices, and specific flavorings such as bread or butter flavoring. Sweeteners include regular and high fructose corn syrup, sucrose (cane or beet sugar), and dextrose, for example. In addition to flavoring the baked good, sweeteners such as sugar can increase the moisture retention of a baked good, thereby increasing its tenderness.

Dough can also include preservatives and mold inhibitors such as sodium salts of propionic or sorbic acids, sodium diacetate, vinegar, monocalcium phosphate, lactic acid and mixtures thereof.

Methods of the invention include the steps of combining ingredients for a dough in a mixing system, configured so that the atmosphere can be controlled, controlling the atmosphere in the mixing system, and mixing the ingredients in the controlled atmosphere to form a resulting dough.

Methods of the invention can be used with any known method of mixing doughs including but not limited to a straight dough method, and a sponge and dough method. Details of a method of the invention can therefore depend in part on the type of dough that is being mixed, and the method of mixing that is generally used with that type of dough. For example, some chemically leavened doughs require a two step process. Methods of the invention can be utilized with two step processes, as well as other types of processes. Methods of the invention can also incorporate varied mixing times. The time a dough is mixed using a method of the invention can depend in part on the type of dough that is being mixed and the general process that is being used.

Generally, the step of combining the ingredients in the mixing system depends on the particular ingredients, the type of dough being mixed, the type of process being used, and the type of mixing system being used. One of skill in the art, having read this specification, would know based on the ingredients being used, the type of process being used, and the type of mixing system being used, and how to accomplish this step.

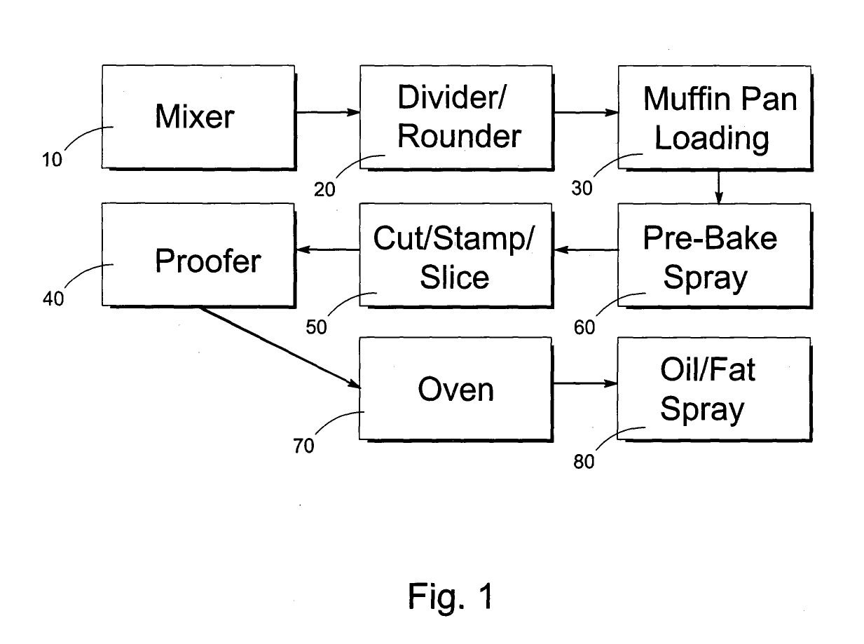

Turning now to FIG. 1, which provides a flow diagram representing the steps in preparing the dough intermediate of the present invention. The ingredients as identified above are added to the mixer 10 and are formed into a dough which may then be extruded and shaped/divided at step 20. Next, the individual dough intermediate are loaded into a baking vessel, here a muffin pan at step 30. Next, a pre-bake spray of oil or liquefied fat (butter) is applied at step 40. After application of the spray and the formation of the plasticized layer, the individual dough intermediates are cut, sliced or stamped depending on the desired ending configuration at step 50. After step 50 the intermediates are introduced into a proofing chamber at step 60 and then baked in an oven at step 70. A further post bake spray may be added at step 80 to provide additional flavoring, sheen or other aesthetic attributes.

As indicated previously, the bake spray or plasticizing spray that is applied to the dough intermediate forms a sealing layer on the dough intermediate. The spray or coating is also forced into the crevices of the intermediate due to the stamping or cutting action designed to produce aesthetic elements. Thus, substantially the entire exposed surface of the dough intermediate is covered with a plasticizing layer. This layer cooperates with the baking vessel or finishing appliance to fluidize the dough and restrict dehydration during the proofing and cooking steps.

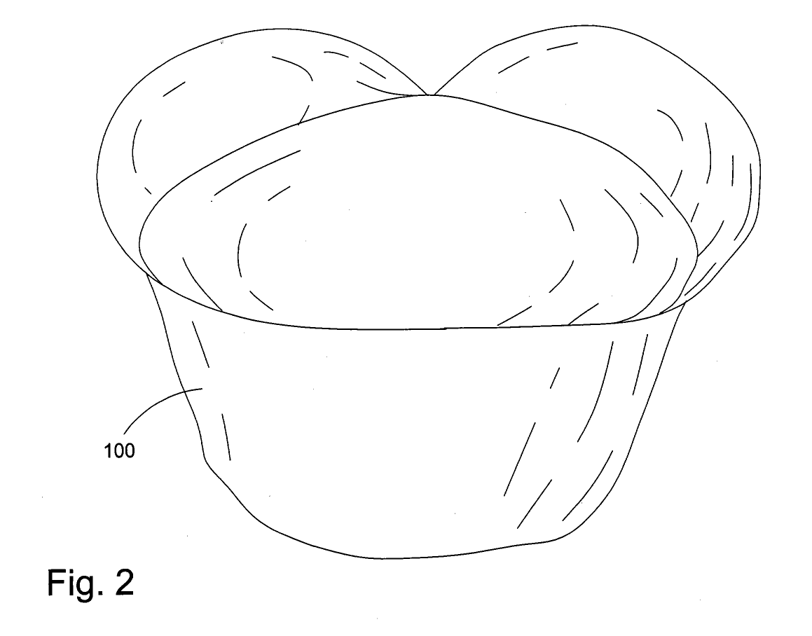

FIG. 2 depicts the dough intermediate in its prepared state or finished condition 100. As can be seen from the FIG. 2, the food product 100 has a series of lobes that are formed as a result of the cutting or stamping that occurred in step 50 in the process described in FIG. 1.

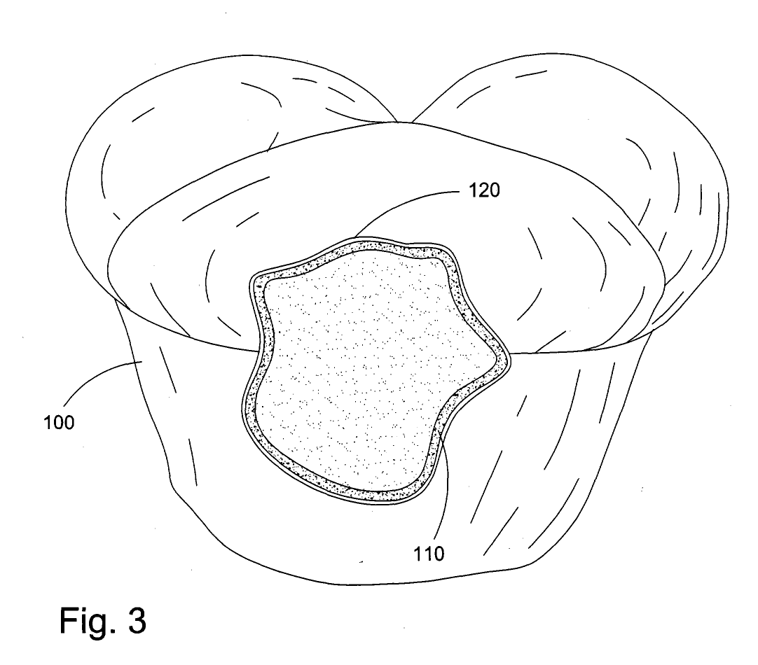

FIG. 3 provides a cut away view of the baked product of the present invention illustrating the plasticized layer 110 immediately adjacent the crown or baked top layer 120 of the finished food product. It is through the creation of the plasticized layer at step 40 in FIG. 1 that aids in the generation of a enhance baked specific volume that is discussed below as well as to aid in the fluidity of the dough and reduction of the dehydration of the dough.

One of the most important characteristics of a baked product is the product's baked specific volume (“BSV”). The BSV of a product relates the volume of the baked product to the weight of the product. Generally, products with higher BSVs are lighter and have more gas or air incorporated therein. Products with lower BSVs are heavy, dense and generally undesirable in developed doughs.

BSV can be measured using commonplace displacement methods. One example of a method commonly used is the rapeseed method. In this method, a baked product of a known mass is placed in a container containing a known and measurable volume of rapeseed. Once the baked product is placed in the container containing the baked product, the volume of the rapeseed and baked product is measured. The specific volume of the baked product is then determined by dividing the volume of the baked product by the mass of the baked product.

Generally, BSV is reported in ml/g developed dough products such as baked breads and rolls generally have BSVs of from about 4 ml/g to 7 ml/g. Dough products, such as baked breads and rolls generally have improved BSVs. Improved BSVs can refer to higher values of BSV or similar values of BSV obtained with a shorter mixing time for the dough. The dough intermediate of the present invention of greater than 3 ml/g and preferably greater than 5 ml/g.

In preparing the dough intermediates of the present invention, a dough is prepared from the following set of ingredients. Enriched flour, water, sugar, partially hydrogenated vegetable oil, yeast, butter, butter oil, salt, egg whites, whey, dough conditioners such as DATEM, calcium sulfate, enzymes, and wheat starch.

Portions of the dough are collected from the mix and are used to form the dough intermediates. The dough portions are placed into cavities, such as those found in a muffin pan, roll or bun moulds or the like. Next, a liquid fat or oil is sprayed onto the surface of dough portion at a rate of approximately 0.35 g per 40 g of dough. After the oil or fat is sprayed onto the surface of the dough, the dough is stamped, cut or sliced to form the desired shape such as a cloverleaf or multiple lobed intermediate or such other shapes as may be desired. The cuts formed by the stamping or cutting may run nearly the entire thickness of the dough intermediate, up to 98% of the dough intermediate or more preferably ranging from approximately 90 to about 98% of the thickness. The creation of such crevices enables the fat or oil spray to embed within the fissures created between the lobes, portions or sections thereby increasing the taste of the product for the ultimate consumer.

The dough intermediate is then proofed to achieve the desired volume and partially baked before storage. The partially baked or “par-baked” dough intermediate may then be stored at refrigerated or under frozen conditions.

The consumer or food service outlet then bakes the dough intermediate to yield the final or end product. Exemplary baking steps include, preheating an oven to a pre-determined temperature, e.g. 325-400° F. and then placing the desired number of dough intermediates into the oven. The intermediates are baked from between 7 to 9 minutes or until the product is thoroughly heated. The baked product may then again be sprayed or coated with fat or oil, such as butter to provide an additional flavor boost to the product as well as to add a shine or glossy coating to the surface of the product. It should be understood that the foregoing additional application step is not necessary to receive the enhanced BSV.

During the par baking or heat or energy (microwave, convention, radiant, etc.) intermediate treatment step of the product produced in accordance with the present invention the lobes or sections produced by the stamping or cutting of the dough intermediate splay outwardly from the center of the baking vessel to produce a greater yield or volume.

Comparisons of the product produced in accordance with the present invention were then made to conventional products prepared in a similar manner without the application of the spray coating. The following table illustrates the improvement in crown height or volume.

| Spray Type Applied | Volume (cm3) | % Increase |
|---|---|---|
| Control | 30.6 | — |
| Soy Oil | 33.3 | 9 |
| Butter Oil | 34.2 | 12 |

As can be seen from the above table the application of the fat/oil spray improved the crown volume, when measuring the circumference of the finished baked product when compared with a product to which no spray has been applied. It was found that the baked products that were not sprayed before baking had a tighter crown that did not expand much beyond the confines of the mould used to form the baking product.

In conducting comparative panels to evaluate the look, feel and taste of the baked product, the product produced in accordance with the present invention generated higher overall liking scores than the unsprayed product as shown in the following table.

| Attribute | Butter/Oil Spray | No Spray |
|---|---|---|
| Flavor | 6.5 | 6.4 |
| Flavor Strength | 4.3 | 4.1 |
| Shape | 7.0 | 6.7 |
| Size | 4.5 | 4.2 |
| Overall Liking | 6.5 | 6.3 |

The confidence level in conducting the above mentioned comparison was 99.2% or higher and generally the confidence level was around 99.9%. The scale range for the categories entitled “flavor”, “shape” and “overall liking” ranged between 1 and 9 with 1 being dislike and 9 being like. The scale range for the category entitled “flavor strength” ranged from 1 to 7, with 1 representing weak flavor and 7 representing strong flavor. Finally, the scale representing the category entitled “size” ranged from 1 to 7 with 1 representing small and 7 representing large.

In other embodiments, the dough intermediate of the present invention can be provided with a filling such as cheese, fruit, confectionary and the like at the time the cutting force is applied to the dough intermediate. Such filling may be extruded or injected into the dough intermediate or disposed on top of the intermediate.

It will thus be seen according to the present invention a highly advantageous dough intermediate having enhanced properties has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A dough intermediate, comprising;
a dough intermediate formed from a mixture, said dough intermediate having a shape intended to produce aesthetic features upon subjecting said dough intermediate to a finishing step, said aesthetic features created through stamping, cutting, slicing or combinations thereof to produce lobes, sections, portions or combinations thereof that are visible after said finishing step;
a plasticizing agent applied to said intermediate at least prior to said finishing step so as to substantially coat an external surface of said intermediate to form a plasticized layer on said external surface of said dough intermediate, said plasticized layer increasing fluidity of the dough intermediate and restricting dehydration to aid in expansion; and
wherein upon subjecting said dough intermediate to an intermediate heat or energy treatment step, said dough intermediate with said plasticized layer yielding an enhanced crown or cap and BSV of greater than 3 ml/g after a final finishing step.

2. A dough intermediate as recited in claim 1, wherein said plasticizing agent is butter.

3. A dough intermediate as recited in claim 1, wherein said plasticizing agent is an oil.

4. A dough intermediate as recited in claim 1, wherein said plasticizing agent is a liquefied fat.

5. A dough intermediate as recited in claim 1, wherein said lobes, sections, portions or combinations thereof are formed by cuts extending up to 98% of said dough intermediate.

6. A dough intermediate as recited in claim 1, wherein said dough intermediate is partially baked prior to releasing said dough intermediate to a retail, wholesale or food service outlet.

7. A dough intermediate as recited in claim 1, wherein said finishing step is selected from the group that includes baking, frying, heating or combinations thereof.

8. A dough intermediate as recited in claim 1, wherein said finishing step is baking at a temperature between 325 and 400° F.

9. A dough intermediate as recited in claim 1, wherein said aesthetic features are lobes on the dough intermediate.

10. A dough intermediate as recited in claim 1, wherein said intermediate heat or energy treatment step is par-baking.

11. A dough intermediate as recited in claim 10, wherein said energy treatment is selected from a group including microwave, convection and radiant.

12. A method of preparing a dough intermediate having improved aesthetic and organoleptic properties upon subjecting the dough intermediate to a finishing step, comprising the steps of;
preparing a dough;
creating individual dough intermediates from said dough;
applying a plasticizing agent to a surface of said dough intermediate to form a partially sealed layer on a surface of said dough intermediate;
providing a cutting force to said dough intermediate to form a plurality of lobes, sections, portions and the like;
treating said dough intermediate to a partial finishing step to create a partially baked dough intermediate;
delivering said partially baked dough intermediate to a retail, wholesale or food service outlet; and
subjecting said partially baked dough intermediate to a final finishing step so as to yield a baked product having improved organoleptic and aesthetic properties.

13. A method of preparing a dough intermediate as recited in claim 10, wherein said plasticizing agent is selected from the group including butter, oil, liquefied fat and combinations thereof.

14. A method of preparing a dough intermediate as recited in claim 10, wherein said cutting force is a mechanical cutting force selected from a group including cutting, stamping, slicing or combinations thereof.

15. A method of preparing a dough intermediate as recited in claim 10, wherein said cutting force is selected from a group including ultrasonic, laser, water or air jetting and combinations thereof.

16. A method of preparing a dough intermediate as recited in claim 10, including a further step of applying an additional coating of plasticizing agent to said partially baked dough intermediate after subjecting said partially baked dough intermediate to a final finishing step.

17. A method of preparing a dough intermediate as recited in claim 12, wherein the cutting force may be applied prior to application of the plasticising agent.

18. A par-baked dough intermediate having a baked specific volume of at least 3 ml/g, said intermediate having a plasticized layer formed from a butter, oil, liquefied fat or combinations thereof; said plasticized layer coated substantially over an exposed surface of said dough intermediate and said plasticized layer is introduced into centrally disposed cuts and crevices through cutting so as to coat lobes, sections or portions to be formed on said dough intermediate upon being subjected to a finishing step and said plasticizing layer improves dough fluidity and reduces dehydration of said dough intermediate.
